(19) United States
(12) Patent Application Publication
(10) Pub. No.: US 2009/0120958 A1
(43) Pub. Date: May 14, 2009

(54) MULTIFLAVOR BEVERAGE DISPENSING NOZZLE AND DISPENSER USING SAME

(76) Inventors: Jerry L. Landers, Memphis, IN (US); Gregory K. Thompson, Louisville, KY (US)

Correspondence Address: BRINKS HOFER GILSON & LIONE/UTAH;UTAH OFFICE, 405 South Main Street, Suite 800, SALT LAKE CITY, UT, 84111-3400, US

(21) Appl. No.: 12/265,555

(22) Filed: Nov. 5, 2008

Related U.S. Application Data
(60) Provisional application No. 60/985,914, filed on Nov. 6, 2007.

(51) Int. Cl. B67D 5/56

(52) U.S. Cl. 222/129.1

(57) ABSTRACT

A multiflavor beverage dispensing nozzle includes at least one water inlet; at least two syrup inlets; a main water flow path through the nozzle; and at least two syrup flow paths through the nozzle, one in fluid communication with each syrup inlet, each terminating in a syrup discharge port. In one aspect the water flow path is shaped to cause the water to discharge from the nozzle in a sheet form, preferably in an annular shape, and the syrup discharge ports include a syrup deflector shaped to cause the syrup to fan out as it exits the discharge port so that it impinges on the sheet of water. In another aspect the nozzle includes at least two secondary water flow paths that each divert water from the main flow path and discharge the diverted water through the at least two syrup discharge ports. A beverage dispenser utilizes a plurality of the multiflavor beverage dispensing nozzles incorporating one or both of the forgoing aspects. Optionally the dispenser also includes one or more dispensing nozzles for dispensing a favor additive, and may be equipped to dispense ice and even have an ice crusher so that it can dispense crushed or cubed ice.

### REFERENCE TO EARLIER FILED APPLICATIONS

The present application claims the benefit of the filing date under 35 U.S.C. § 119(e) of Provisional U.S. patent Application Ser. No. 60/985,914; which is hereby incorporated by reference in its entirety.

### BACKGROUND OF THE INVENTION

The present invention relates to beverage dispensers and multiflavor dispensing nozzles used thereon.

Beverage dispensers commonly mix a flavored concentrate with water to produce and dispense a beverage into a cup or other container for immediate consumption. Such dispensers are common in foodservice environments, such as fast-food restaurants and cafeterias. The water may be carbonated or non-carbonated, and many beverage dispensers are designed to be able to dispense both carbonated and non-carbonated beverages. Some beverage dispensers also dispense ice.

Consumers appreciate having a wide selection of beverages to choose from. Thus most beverage dispensers are designed to mix different flavored concentrates, or syrups, with the water to produce different flavors of beverages. Most dispensers have nozzles where the syrup and water mix to form the beverage, and each nozzle is connected to one syrup supply, and thus dispenses only one flavor of beverage, until the syrup supplied to that nozzle is switched. Such a beverage dispenser thus needs to have as many different nozzles as the desired number of beverages to be dispensed.

Countertop space for beverage dispensers is often at a premium in the foodservice environment. Accommodating a large number of mixing nozzles on a dispenser increases the size, and hence the “footprint” of the dispenser. There have thus been designs for multiflavor nozzles for beverage dispensers, where each nozzle is attached to several syrup supply sources. Valves control which syrup is delivered to the nozzle, but one nozzle is thus able to dispense several different flavors of beverages from a single dispensing point, thereby increasing the number of flavors of beverages that can be dispensed from dispenser while maintaining a small footprint on the countertop.

One common problem with a multiflavor nozzle is the carry-over mixing of flavors from one drink to the next. If any syrup or mixture of syrup and water remains in the nozzle or on a surface of it when the first beverage is finished being dispensed, then that syrup or mixed syrup and water will likely be combined with the next beverage to be dispensed. In multiflavor nozzles, this can produce a carry-over when the next beverage is of a different flavor than the beverage dispensed before it. This is particularly noticeable where a dark colored beverage is dispensed and then a clear or light colored beverage is dispensed from the same nozzle.

Another problem that can occur with any mixing nozzle is incomplete mixing of the syrup and water. If the mixing is not complete, the drink in the cup may be “stratified”, with different ratios of syrup and water at different levels in the cup. The lack of complete mixing is a greater potential problem in a multiflavor nozzle because the design of the nozzle must accommodate several different syrup supply points within the nozzle.

Another consideration for a dispensing nozzle is the aesthetic appearance of the beverage as it is being dispensed. Many beverage dispenses are set up for self service use, meaning that the consumer actuates the valves to select the desired flavor and positions the cup to receive the beverage. The consumer thus sees the beverage as it is being dispensed from the nozzle into the cup. It would be beneficial if the dispensing nozzle produced a beverage flow where the mixing of the syrup and the water presented a pleasing appearance to the consumer. Again, this effort is complicated in a multiflavor nozzle, where the syrup is introduced from different supply points in the nozzle.

While multiflavor nozzles are known, there is still a long felt need for a nozzle that avoids carry-over, produces a well-mixed drink, and presents a pleasing appearance as the beverage is being dispensed. On top of these requirements, it would be beneficial if the nozzle were easy to dissemble for cleaning, and low in cost to manufacture.

Thus, a multiflavor dispenser that could meet these different requirements would be a great improvement.

### BRIEF SUMMARY

An improved multiflavor beverage dispenser has been invented. In one embodiment, four different flavors of beverages can be dispensed from the same nozzle. With the preferred embodiment of the invention, the syrup and water are combined in an aesthetically pleasing manner, and cross-flavor contamination between dispensing of different beverages is prevented.

In a first aspect, the invention is a multiflavor beverage dispensing nozzle comprising at least one water inlet; at least two syrup inlets; a water flow path through the nozzle that causes the water to discharge from the nozzle in a sheet form; and at least two syrup flow paths through the nozzle, one in fluid communication with each syrup inlet, each terminating in a syrup discharge port that includes a syrup deflector shaped to cause syrup flowing through the syrup flow path to fan out as it exits the discharge port so that it impinges on the sheet of water.

In a second aspect, the invention is a multiflavor beverage dispensing nozzle comprising at least one water inlet; at least two syrup inlets, a main water flow path through the nozzle; at least two syrup flow paths through the nozzle, one in fluid communication with each syrup inlet, each terminating in a syrup discharge port; and at least two secondary water flow paths that each divert water from the main flow path and discharge the diverted water through one of the at least two syrup discharge ports.

In another aspect, the invention is a beverage dispenser comprising a plurality of multiflavor mixing and dispensing nozzles, each multiflavor nozzle comprising at least one water inlet; at least two syrup inlets; a water flow path through the nozzle that causes the water to discharge from the nozzle in a sheet form; and at least two syrup flow paths through the nozzle, one in fluid communication with each syrup inlet, each terminating in a syrup discharge port that includes a syrup deflector shaped to cause syrup flowing through the syrup flow path to fan out as it exits the discharge port so that it impinges on the sheet of water.

In still another aspect, the invention is a beverage dispenser comprising a plurality of multiflavor mixing and dispensing nozzles, each multiflavor nozzle comprising at least one water inlet; at least two syrup inlets; a main water flow path through the nozzle; at least two syrup flow paths through the nozzle, one in fluid communication with each syrup inlet, each terminating in a syrup discharge poll; and at least two secondary water flow paths that each divert water from the main flow path and discharge the diverted water through one of the at least two syrup discharge ports.

With the preferred embodiment of the invention, one nozzle can be used to dispense up to four different flavors, which allows for a wide variety of beverages to be dispensed with a dispenser having a small footprint. At the same time, the nozzle dispenses a beverage with a pleasing presentation, which is well mixed as it falls into the cup, and the syrup does not stay in the end of the syrup passageway where it would otherwise likely be dislodged when the next drink is dispensed, causing flavor carry-over.

These and other advantages of the invention, as well as the invention itself, will best be understood in view of the drawings, a brief description of which is as follows.

### BRIEF DESCRIPTION OF THE DRAWINGS

FIG. 1 is a side perspective view of an ice and beverage dispenser of the present invention.

FIG. 2 is a side perspective view of a portion of the ice and beverage dispenser of FIG. 1 with the front cover removed.

FIG. 3 is a cross-sectional view of a multiflavor beverage dispensing nozzle of a first embodiment of the invention, taken along line 3-3 of FIG. 2, showing the water flow path.

FIG. 4 is different cross-sectional view of the multiflavor beverage dispensing nozzle of FIG. 3, showing two of the syrup flow paths.

FIG. 5 is all exploded view of the multiflavor beverage dispensing nozzle of FIG. 3.

FIG. 6 is a top perspective view of a water lid used in the multiflavor beverage dispensing nozzle of FIG. 3.

FIG. 6A is a top perspective view of an alternate configuration of the water lid of FIG. 6.

FIG. 7 is a bottom perspective view of the water lid of FIG. 6.

FIG. 7A is a bottom perspective view of the alternate embodiment of the water lid of FIG. 6A.

FIG. 8 is a top perspective view of a water distributor used in the multiflavor beverage dispensing nozzle of FIG. 3.

FIG. 8A is a top perspective view of an alternate configuration of the water distributor of FIG. 8.

FIG. 9 is a bottom perspective view of the water distributor of FIG. 8.

FIG. 9A is a bottom perspective view of the alternate embodiment of the water distributor of FIG. 8A.

FIG. 10 is a top perspective view of a syrup base used in the multiflavor beverage dispensing nozzle of FIG. 3.

FIG. 11 is bottom perspective view of the syrup base of FIG. 10.

FIG. 12 is a top perspective view of a bottom nozzle member used in the multiflavor beverage dispensing nozzle of FIG. 3.

FIG. 13 is a bottom perspective view of the bottom nozzle member of FIG. 12.

FIG. 14 is a cross-sectional view of a second multiflavor beverage dispensing nozzle of the present invention.

FIG. 15 is a top perspective view of an alternate configuration of the syrup base of FIG. 10.

FIG. 16 is an exploded bottom perspective view of an alternate embodiment of a syrup deflector that could be used in the multiflavor beverage dispensing nozzle of FIG. 3.

FIG. 17 is perspective view of the alternate embodiment of the syrup deflector of FIG. 16.

### DETAILED DESCRIPTION OF THE PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The term “sheet” used in the specification and claims has a meaning defined as follows. The term “sheet” designates a form of water flow that has a small thickness dimension and a substantially longer other dimension. The sheet need not be, and is typically not, flat. Rather, the sheet form of water flow will typically be hollow cylinder, with a conical component as the sheet form collapses into a solid stream.

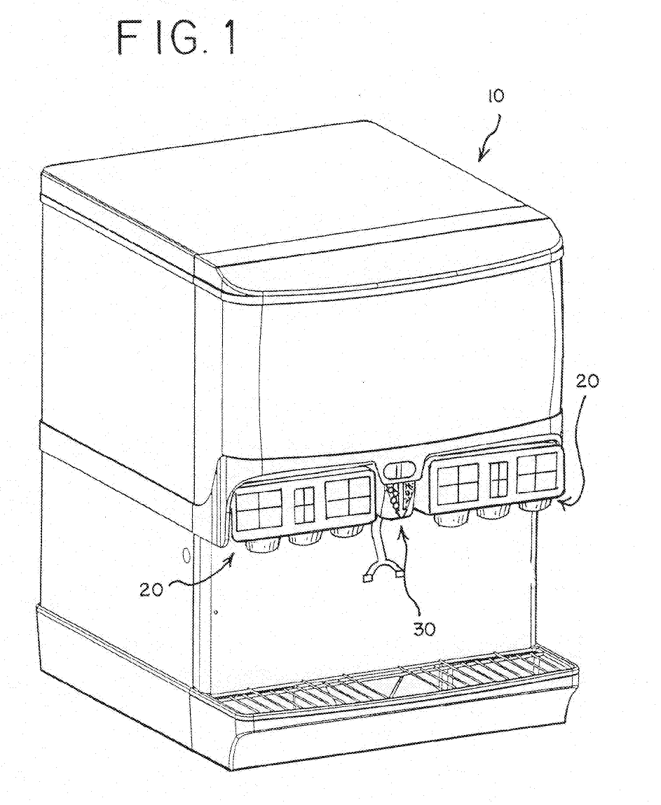

FIG. 1 depicts an embodiment of a combined ice and beverage dispenser 10 of the present invention. The dispenser 10 has six beverage dispensing modules 20, each of which may include a multiflavor beverage dispensing nozzle and a multi-pad push button flavor selection panel. In the preferred embodiment shown, the dispenser 10 also includes an ice dispensing chute 30. The dispenser 10 includes many elements that are conventional, such as a drip tray, and conventional elements that are not shown, such as an ice bin, an agitator, a cold plate, a carbonator, and the like.

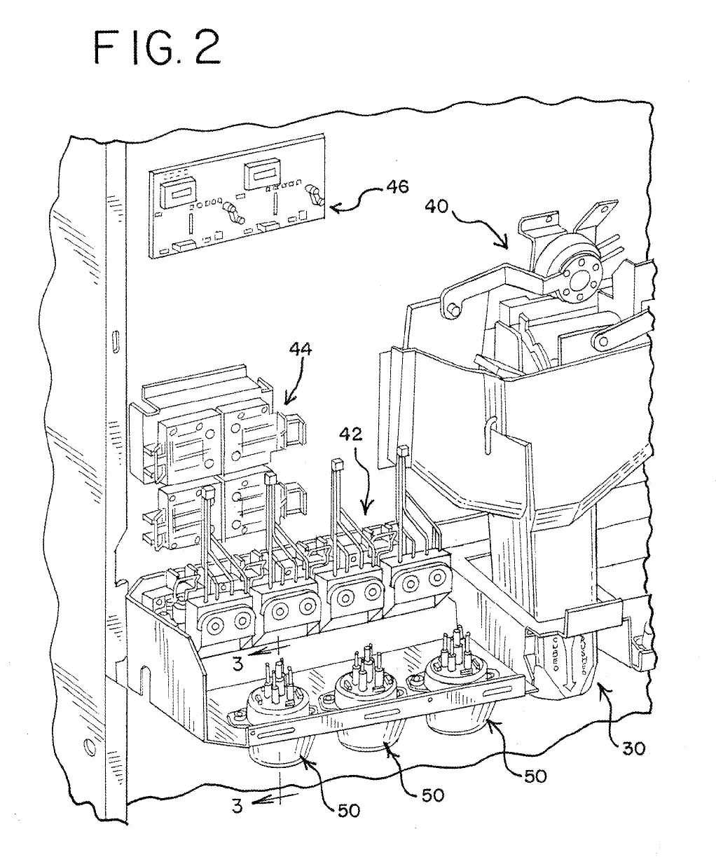

The preferred ice and beverage dispenser 10 is equipped with an ice crusher assembly 40, best seen in FIG. 2, (The dispenser front cover and a number of other parts, such as syrup and water lines, are not shown in FIG. 2 for sake of clarity.) Preferably the dispensers can dispense either crushed or cubed ice. More preferably the ice and beverage dispenser can dispense either crushed or cubed ice through the same ice dispensing chute 30. Ice and beverage dispensers that dispense both crushed and cubed ice are disclosed in commonly owned U.S. patent application Ser. No. 11/514,715, fled Sep. 1, 2006, and entitled ICE/BEVERAGE DISPENSER WITH IN-LINE ICE CRUSHER, published as US 2007/0193299 A1, which is hereby incorporated by reference.

The dispenser 10 uses standard pumps, valves and ceramic flow controls (not shown) to supply syrups from plural sources of supply, such as bag-in-box syrups, to the multiflavor beverage dispensing nozzles 50. The dispenser 10 includes circuit board 46 for controlling various machine functions. Four empty valve mounting blocks X are shown in FIG. 2, and four sets of valves 42, also mounted on mounting blocks, are shown. Since two valves can be mounted on each block, up to 16 different fluids can be controlled with the number of valves and mounting blocks shown on the left side of the dispenser 110 in FIG. 2. These will control the flow of water (either carbonated or non-carbonated) and syrup to the different inlets on each multiflavor beverage dispensing nozzle 50. For the three multiflavor beverage dispensing nozzles 50 shown on the left side of the dispenser, with one water and four syrups each, only 15 of the possible 16 valves need to be used.

In the dispenser 10, each nozzle is hard plumbed to only one source of water, and each beverage dispensed for that nozzle will thus either need to be carbonated or non-carbonated. Alternatively, a carbonated and non-carbonated water line could be connected to each water inlet, or the nozzles could be equipped with two water inlets so that both carbonated and non-carbonated beverages could be dispensed from the same nozzle. Also, instead of being hard plumbed, the dispenser 10 may be equipped with a selection manifold connected between sources of both carbonated and non-carbonated water. The manifold has a selecting mechanism allowing a user of the apparatus to easily switch between directing carbonated and non-carbonated water through the water line to the valve supplying water to a given nozzle. Exemplary selection manifolds are disclosed in U.S. Pat. No. 6,698,621, which is also incorporated herein by reference.

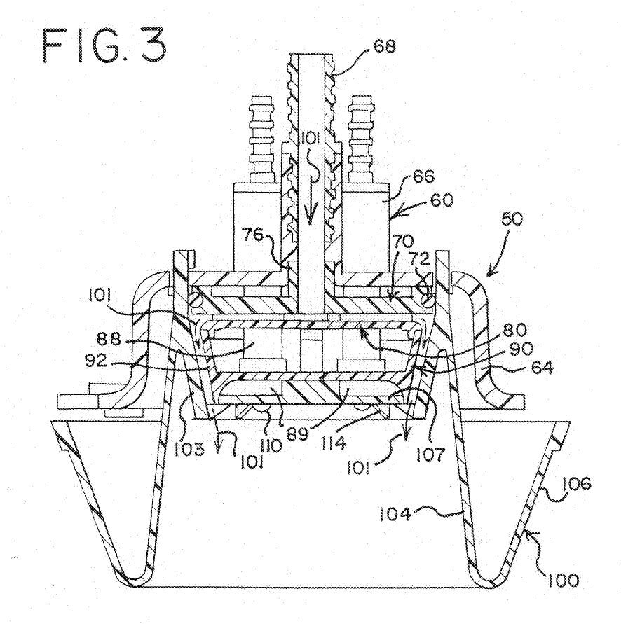

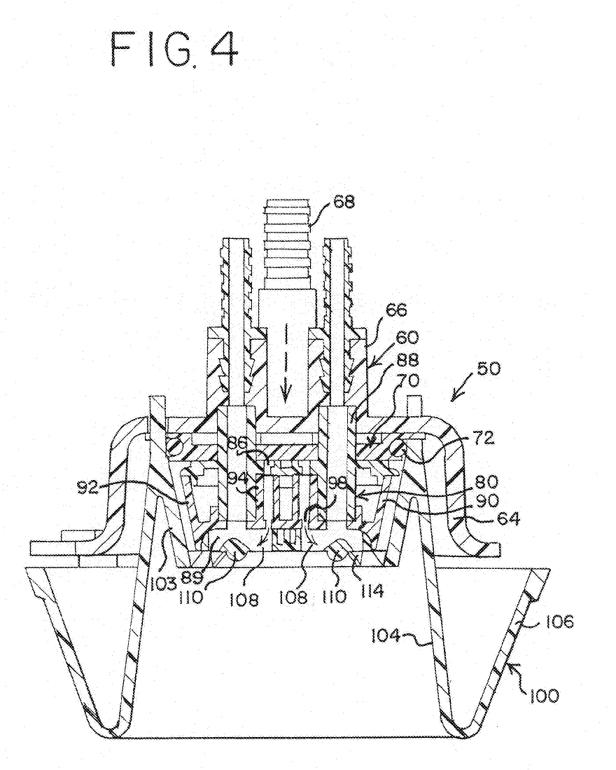

A first embodiment of a multiflavor beverage dispensing nozzle 50 is shown in FIGS. 3-13. As best seen in FIGS. 3 and 4, and as explained in more detail below, each multiflavor beverage dispensing nozzle includes at least one water inlet 68; at least two syrup inlets 66; a main water flow path through the nozzle; and at least two syrup flow paths through the nozzle, one in fluid communication with each syrup inlet, each terminating in a syrup discharge port. The water flow path is shaped to cause the water (which may be either carbonated or non-carbonated, depending on what is supplied to the nozzle) to discharge from the nozzle in a sheet form, preferably in an annular shape. The syrup discharge ports include a syrup deflector shaped to cause the syrup to fall out as it exits the discharge port so that it impinges on the sheet of water. The nozzle includes at least two secondary water flow paths that each divert water from the main flow path and discharge the diverted water through one of the at least two syrup discharge ports.

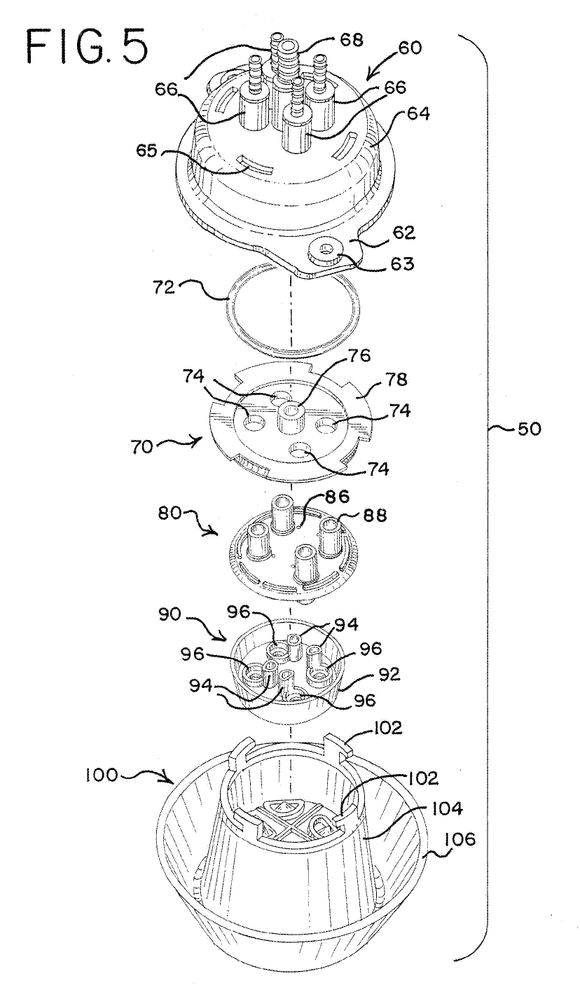

FIG. 5 shows, in an exploded form, the various parts used to make the multiflavor beverage dispensing nozzle 50. These include a nozzle mounting base 60, a water lid (also referred to as a first disk) 70, a water distributor (also referred to as a second disk) 80, a syrup base 90 and a bottom nozzle member 100. Each of these parts can be injection molded and then assembled to form the nozzle 50. Parts 60, 70, 80 and 90 are sonically welded together to form an assembly. Bayonet connectors 102 on the bottom nozzle member 100 insert through slots 65 in the nozzle mounting base 65 with the other parts sandwiched in between them. Rotation of the bottom nozzle member 100 with respect to the mounting base 60 locks the bottom nozzle member 100 to the rest of the nozzle. Mounting holes 63 in flanges 62 of the mounting base 60 are used to secure the nozzle 50 to the rest of the module 20 and dispenser 10. When it is time to clean the nozzle 50, the bottom nozzle member 100 is rotated in the opposite direction to release the bayonet lock, and the part 100 can come apart from the mounting base 60. Flange 78 on the water lid forms the bottom of the O-ring groove to hold O-ring 72 in place. The spaces 75 allow the connectors 102 to pass through so they lock on the base 60.

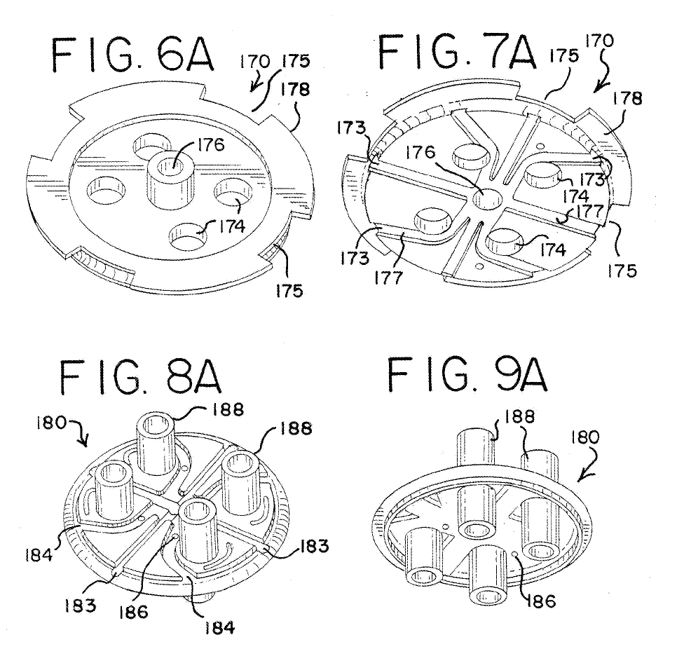

The water flow path through the nozzle 50 is best seen in FIG. 3. Arrows 101 depict the flow of water through the nozzle 50. Water enters the nozzle 50 through a centrally disposed inlet 68 and flows in an axial direction along a central axis from the inlet 68 into the center tube 76 of water lid 70. This center tube 76 fits snuggly into a recess in center of the mounting base 60. Next the main water flow path is radial in nature, defined by the space between the water lid 70 and water distributor 80. The water passes out of this space through gaps 73 formed in a wall 77 on the bottom of the water lid 70 (FIG. 7) and gaps 84 formed in a wall 82 on the top of water distributor 80 (FIG. 8). O-ring 72 seals the space between the water lid 70 and the bottom nozzle member 100.

There is an annular region in the water flow path downstream of the radial flow path. This next part of the water flow path includes a space defined between two conical wall surfaces of the syrup base 90 and the bottom nozzle member 100. The outer surface of wall 92 of syrup base 90 and an inner surface of wall 103 of bottom nozzle member 100 force the water to flow downwardly in a converging annular space. The water discharges through an annular opening at the end of its flow path. The flow path between the conical walls causes the water to form into a sheet as it discharges. The sheet is in the general form of a hollow cylinder, but the velocity of the water and the angle of the conical surfaces on walls 92 and 103 causes the water sheet to converge as it falls from the nozzle. In addition, the natural surface tension of the water further contributes to the water sheet collapsing further as it falls below the bottom of the nozzle 50. Wails 104 and 106 provide a decorative aspect to the nozzle 50, and obscure visual observation of the beverage flow to a point below the bottom of the nozzle 50 where the syrup and water are well mixed.

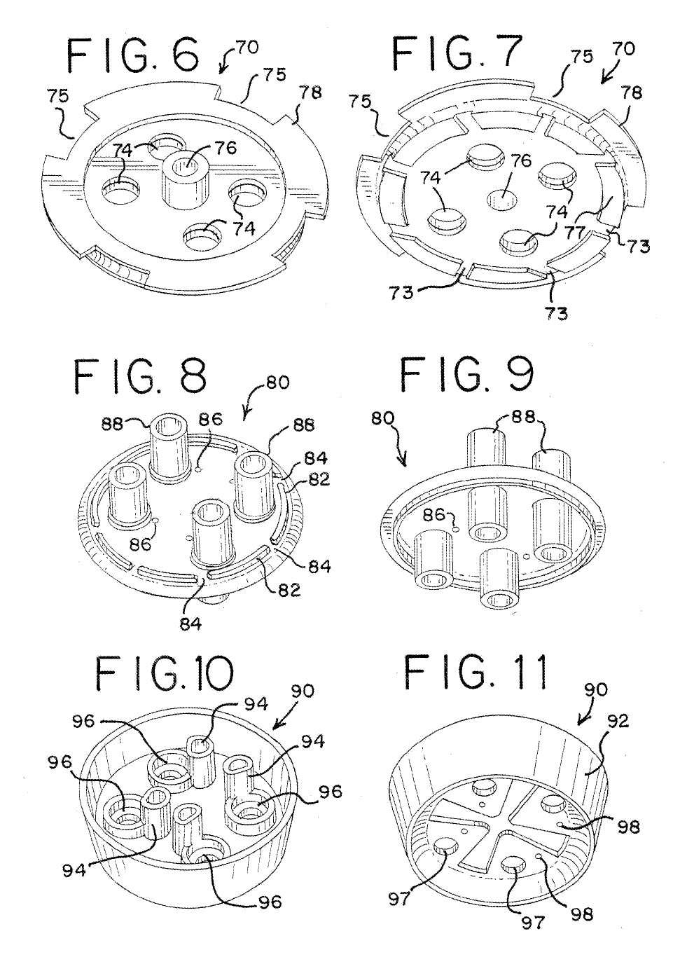

The multiflavor beverage dispensing nozzles 50 are designed to accommodate four different syrup flavors, but could be configured to dispense two, three, five or more different flavors of beverage as well. Each nozzle 50 includes four syrup inlets 66, four syrup flow paths and four syrup discharge ports. The syrup flow paths for two of these are shown in FIG. 4. The syrup enters the nozzle through a hose or other conduit attached to the fitting providing the inlet 66 on the nozzle mounting base 60. The syrup flow path is defined in part by holes through the two disks, water lid 70 and water distributor 80. Water distributor 80 includes four hollow tubes 88 formed monolithically with the rest of the disk 80 (FIGS. 8 and 9) when it is molded. That disk thus includes the holes in the tubes 88. As seen in FIG. 4, the tubes 88 pass through holes 74 (FIG. 6) formed in water lid 70. The tubes 88 extend up into recesses formed in the bottom of the nozzle mounting base 60 when the nozzle 50 is assembled. On the downstream side, the tubes 88 fit into recesses 96 formed in syrup base 90 (FIG. 10). Holes 97 (FIG. 11) through the syrup base 90 deliver the syrup from the tubes 88 into syrup chambers 89 formed between the syrup base 90 and the bottom horizontal wall 107 (FIG. 3) of the bottom nozzle member 100. The bottom horizontal wall 107 is attached to wall 103 by gussets 114. Of course there is a gap between the bottom horizontal wall 107 and wall 103 where the water stream discharges. The gussets 114 are designed to be as thin as possible so as not to impede the water flow.

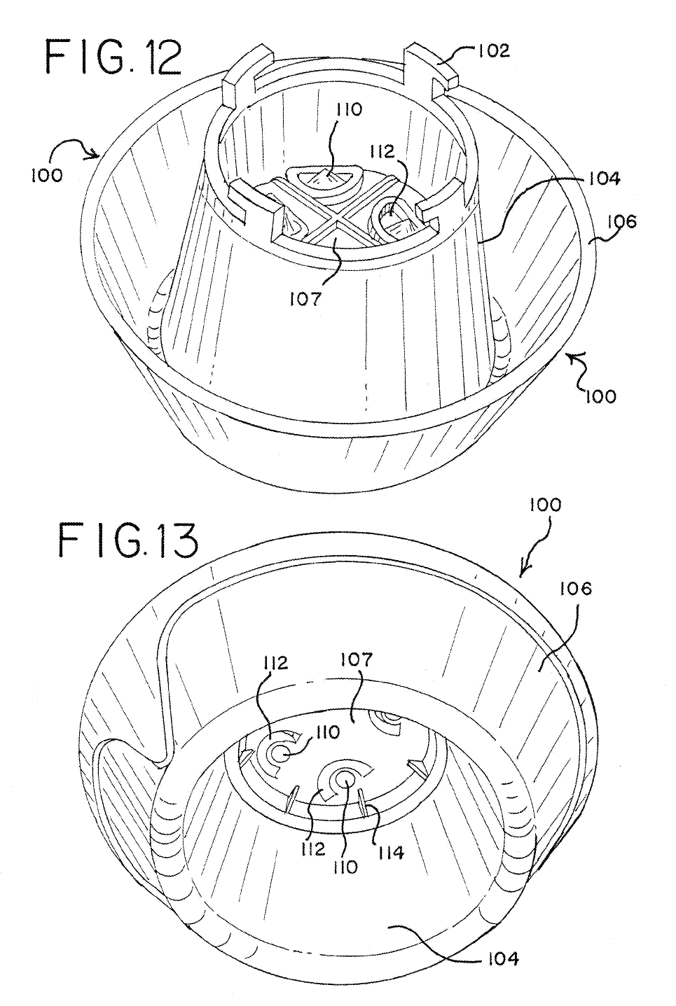

The syrup chamber 89 is just upstream of the syrup discharge port 112 (FIG. 13) formed in the bottom horizontal wall 107 of the bottom nozzle member 100. Each syrup discharge port includes a syrup deflector 110 shaped and positioned to cause the flow of syrup through the port to fan out predominantly to one side of the nozzle. FIG. 12 shows the upper surface of the syrup deflector as being conical. The discharge port 112 is semicircular, and the syrup deflector 110 resides on a tab that fills up part of the semicircular area, as best seen in FIG. 13.

Preferably the syrup deflector is shaped to cause the flow of syrup through the port to fan out to impinge on at least half of the annular surface of the water sheet. Thus the syrup discharge ports each discharge syrup into the converging water flow path. Also, the syrup deflectors are preferably positioned and shaped to cause the syrup to fan out toward either the front or back of the nozzle (the front and back being relative terms, but designating positions compared to the dispenser on which the nozzles are installed). While all of the deflectors can direct the syrup towards the front (as shown in the present drawings), it has been found that the deflectors on one side should direct the fan of syrup across to the opposite side of the water flow. In this way, if the syrup flow rate varies, and is sometimes relatively high (due to the type of syrup pump being used), the syrup flow rate will be spread out further and not cause the syrup to disrupt the water flow.

Thus two deflectors in two of the different discharge ports will preferably deflect flow to the same first side of the nozzle, and the other two will deflect flow to the same second side (opposite to the first side) of the nozzle. This will preferably be towards the front and back of the dispenser when the modules 20 are in place and the bottom nozzle member 100 is in its correct position such that the bayonet connectors 102 are locked into place though slots 65. Thus, when a consumer stands in front of the dispenser 10 and activates a push button on module 20, the selected syrup flow will pass through the nozzle 50 and be discharged towards the inside surface of the water on the side of the flow closest to the consumer for two of the flavors, and the side of the flow farthest from the consumer for the other two flavors, both of these arrangements presenting an aesthetically pleasing flow and mixing of the syrup and water.

To help prevent flavor carry-over from one drink to the next, the nozzle 50 also includes a secondary water flow path for each syrup flow path. The secondary water path discharges a small amount of water into each syrup chamber 89 whenever water is flowing in the main water flow path. This secondary water serves two purposes. First, because it is under pressure, the velocity of the water in this secondary path helps to force syrup out of the syrup chamber. Second, the water is introduced into and mixes with the syrup in the chamber 89, this reducing its viscosity. As a result, the syrup in the chamber will all drain from the chamber 89 when the flow of syrup is stopped. The syrup in tube 88 will have a high enough viscosity and surface tension that it will form a meniscus and stay up inside of tube 88.

The secondary water flow paths each comprise a hole 86 through the water distributor 80 (FIGS. 8 and 9), and thus draw water from the main flow path out of the radial portion of the water flow path. The secondary water flow path includes hollow tubes 94 (FIG. 10) that are formed monolithically with the rest of syrup base 90 when it is molded. The syrup base 90 has small holes 98 out of the bottom of tubes 94. FIG. 4 shows arrows 108 representing the flow of secondary water out of holes 98 into syrup chambers 89.

FIGS. 6A, 7A, SA and 9A depict an alternate configuration for the spaced apart disks, water lid 70 and water distributor 80. For the most part the water lid 170 and water distributor 180 have the same functional parts as water lid 70 and water distributor 80, such as holes 174, flanges 178, spaces 175, and tube 176 on water lid 170, and tubes 188 and holes 186 on water distributor 180. The main difference, however, is the way that the water lid 170 and water distributor 180 cooperate to form the radial flow path for the main water flow. With water lid 70 and water distributor 80, the entire area between the disks in their central region gets flooded. While the water flow path is still a radial flow path defined by two spaced apart disks 170 and 180, the water is channeled in specific channels 183 formed in the top of water distributor 180, and channels 177 formed in the bottom of water lid 170. These channels still have outlets 173 and 184, which are like the gaps 73 and 84 in water lid 70 and water distributor 80, that feed into the annular area between walls 92 and 103.

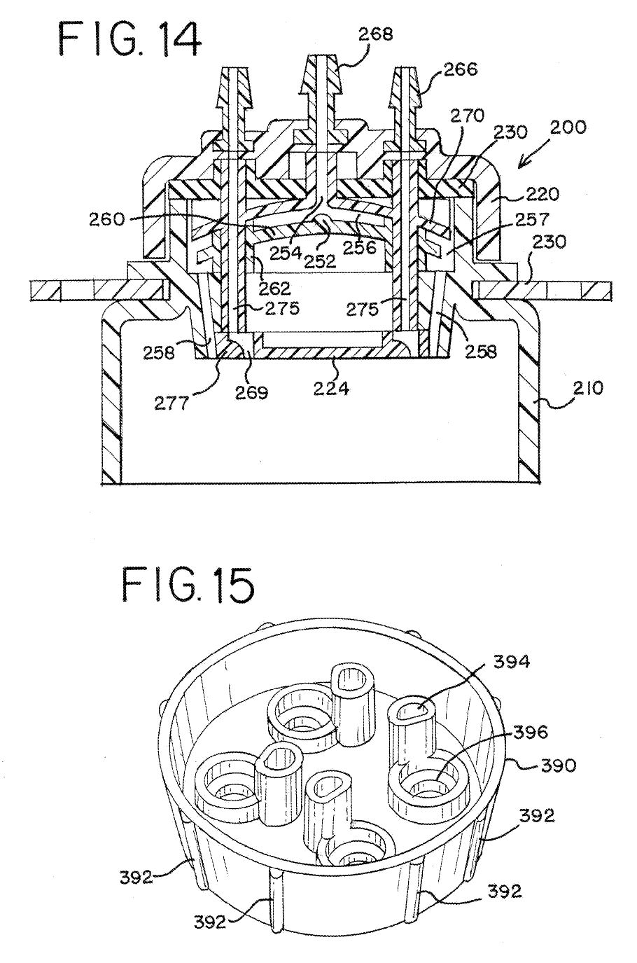

FIG. 14 shows a cross section of an alternate embodiment of a multiflavor beverage dispensing nozzle 200. The nozzle 200 has many of the same components as nozzle 50, although some of them are shaped differently. For example, it includes a mounting base 220 that includes water inlet 268 and syrup inlets 266, a removable bottom nozzle member 210, a water lid 270, and a water distributor 260. There are some additional parts, such as a top plate 230 that fits inside the nozzle mounting base 220 to provide centering for tubes making up the water flow path aid syrup flow paths. These tubes are formed monolithically with the water lid 270. Water distributor 260 includes tubes 262 formed monolithically with the rest of the disk. Tubes 262 provide welding points for the assembly and create the proper spacing between water distributor 260 and water lid 270 for the water flow feeding area 257. In nozzle 200 the water flows axially down channel 254 and is redirected radially by bump 252. From bump 252 the water flows radially in the space 256 between the water lid 270 and the water distributor 260 into an annular chamber 257. From there the water flows through channel 258 in the form of an annular, inwardly sloping space formed between two conical surfaces, just as in nozzle 50. The syrup flows down channel 275 and is fanned out by syrup deflector 277 as it exits the syrup discharge port 269 formed in bottom wall 224. While the embodiment of nozzle 200 does not include any secondary flow paths for water to flush out syrup chambers located above discharge ports 269, such flow paths could be added.

FIG. 15 shows an alternate embodiment of a syrup base 390. Syrup base 390 is just like syrup base 90 in most respects, including hollow tubes 394 used to carry the secondary water flow, and recesses 396 for syrup tubes 88. Syrup base 390, however, includes ribs 392 on the outer wall surface. These ribs may be used in some embodiments of the nozzle 50 if they are needed to balance out the water flow so that it is evenly distributed around the perimeter of the syrup base.

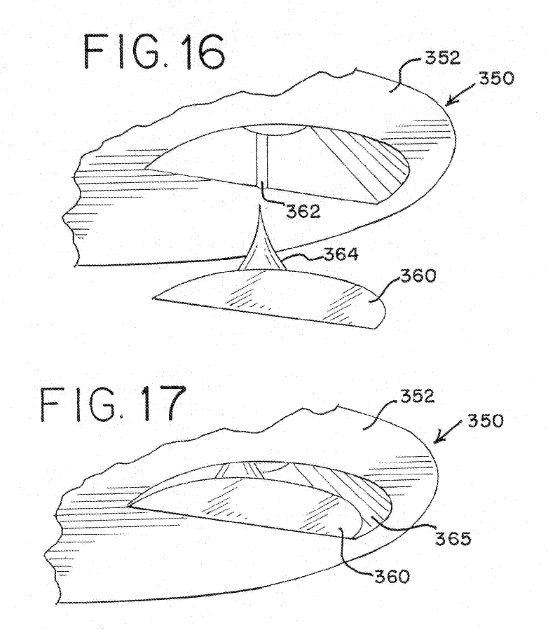

FIGS. 16 and 17 depict an alternate way to provide a syrup deflector. In this embodiment, the deflector 360 is molded as a separate piece. The bottom wall 352 of the nozzle member 350 has a channel 362 molded into it. Opposite the sloped surface 364 of the deflector, a mating ridge (not shown) is molded with the part. The ridge slides into channel 362 when the deflector 360 is added to the rest of the nozzle 350. It may be glued in place or secured by a close tolerance fit. Syrup exiting the discharge port 365 hits the inclined surface 364 and fans out, as described with earlier embodiments.

The multiflavor beverage dispensing nozzles disclosed herein provide many advantages. Not only do they allow multiple beverages to be dispensed from the same nozzle, but they avoid the problem of flavor carry-over between different beverages. Also, they provide a well mixed drink, and they present an aesthetically pleasing beverage pour presentation. Further, the preferred embodiment is made from injection molded parts that are low cost to manufacture and easy to assemble, yet the decorative bottom nozzle member can easily be removed for cleaning.

It should be appreciated that the apparatus of the present invention is capable of being incorporated in the form of a variety of embodiments, only a few of which have been illustrated and described above. For example, instead of all six of the modules 20 including a multiflavor beverage dispensing nozzle, one or more of the modules could be equipped with a standard nozzle that dispenses just one flavor of beverage, or the dispenser could include one or more nozzles from which an additional flavor may be dispensed into a cup to provide an extra shot of flavor to a particular beverage. The invention may be embodied in other forms without departing from its spirit or essential characteristics. The described embodiments are to be considered in all respects only as illustrative and not restrictive, and the scope of the invention is therefore indicated by the appended claims rather than by the foregoing description. All changes which come within the meaning and range of equivalency of the claims are to be embraced within their scope.

1. A multi flavor beverage dispensing nozzle comprising:
a) at least one water inlet;
b) at least two syrup inlets;
c) a water flow path through the nozzle that causes the water to discharge from the nozzle in a sheet form; and
d) at least two syrup flow paths through the nozzle, one in fluid communication with each syrup inlet, each terminating in a syrup discharge port;
e) the at least two syrup discharge ports including a syrup deflector shaped to cause syrup flowing through the syrup flow path to fan out as it exits the discharge port so that it impinges on the sheet of water.

2. The multiflavor beverage dispensing nozzle of claim 1 wherein the water flow path includes an annular region at its terminal end, causing the water sheet to be in the general form of a hollow cylinder.

3. The multiflavor beverage dispensing nozzle of claim 1 wherein the syrup deflector is shaped and positioned to cause the flow of syrup through the port to fan out predominantly to one side of the nozzle.

4. The multiflavor beverage dispensing nozzle of claim 3 wherein the syrup deflectors in both discharge ports cause the syrup to fan out toward the same side of the nozzle.

5. The multiflavor beverage dispensing nozzle of claim 2 wherein the syrup deflector is shaped to cause the flow of syrup through the port to fan out to impinge on at least half of the annular surface of the water sheet.

6. The multiflavor beverage dispensing nozzle of claim 1 wherein the nozzle comprises four syrup inlets and four syrup flow paths and four syrup discharge ports.

7. The multiflavor beverage dispensing nozzle of claim 2 wherein the water flow path includes a radial flow path defined by two spaced apart disks.

8. The multi-flavor beverage dispensing nozzle of claim 7 wherein the annular region of the flow path is downstream of the radial flow path.

9. The multiflavor beverage dispensing nozzle of claim 1 wherein the water flow path includes a space defined between two conical wall surfaces and the water discharges through an annular area in a flow path that tends to converge.

10. A multiflavor beverage dispensing nozzle comprising;
a) at least one water inlet;
b) at least two syrup inlets;
c) a main water flow path through the nozzle;
d) at least two syrup flow paths through the nozzle, one in fluid communication with each syrup inlet, each terminating in a syrup discharge port; and
e) at least two secondary water flow paths that each divert water from the main flow path and discharge the diverted water through one of the at least two syrup discharge ports.

11. The multiflavor beverage dispensing nozzle of claim 10 wherein the water inlet includes an axial flow path into the nozzle along a central axis and a radial flow between two spaced apart disks.

12. The multiflavor beverage dispensing nozzle of claim 11 wherein the secondary water flow paths each comprise a hole through one of the disks defining the radial water flow path.

13. The multiflavor beverage dispensing nozzle of claim 10 wherein the water flow path includes a space defined between two conical wall surfaces and the water discharges through an annular area in a flow path that tends to converge, and the syrup discharge ports each discharge syrup into the converging water flow path.

14. The multi flavor beverage dispensing nozzle of claim 10 wherein the syrup discharge ports include a syrup deflector shaped to cause syrup flowing through the syrup flow path to fan out as it exits the discharge port.

15. The multiflavor beverage dispensing nozzle of claim 10 wherein the water flow path is in part defined by a space between two disks, and the syrup flow path is defined in part by holes through the two disks.

16. The multiflavor beverage dispensing nozzle of claim 15 wherein the syrup flow path is defined in part by a tube that is formed monolithically with one of the two disks, and the tube passes through a hole in the other of the two disks.

17. The multiflavor beverage dispensing nozzle of claim 16 wherein the tube empties into a syrup chamber upstream of the syrup discharge port, and the secondary water flow path also discharges into said syrup chamber.

18. A beverage dispenser comprising a plurality of multiflavor beverage dispensing nozzles, cacti nozzle comprising:
a) at least one water inlet;
b) at least two syrup inlets;
c) a water flow path through the nozzle that causes the water to discharge from the nozzle in a sheet form; and
d) at least two syrup flow paths through the nozzle, one in fluid communication with each syrup inlet, each terminating in a syrup discharge port;
e) the at least two syrup discharge ports including a syrup deflector shaped to cause syrup flowing through the syrup flow path to fan out as it exits the discharge port so that it impinges on the sheet of water.

19. The beverage dispenser of claim 18 wherein the dispenser also includes an ice dispensing chute.

20. The beverage dispenser of claim 19 wherein the dispenser also includes an ice crusher, and the dispenser can dispense either crushed or cubed ice through the ice dispensing chute.

21. The beverage dispenser of claim 18 wherein the dispenser further includes a nozzle from which an additional flavor may be dispensed into a cup.

22. A beverage dispenser comprising a plurality of multiflavor beverage dispensing nozzles, each nozzle comprising:
a) at least one water inlet;
b) at least two syrup inlets;
c) a main water flow path through the nozzle;
d) at least two syrup flow paths through the nozzle, one in fluid communication with each syrup inlet, each terminating in a syrup discharge poll; and
e) at least two secondary water flow paths that each divert water from the main flow path and discharge the diverted water through one of the at least two syrup discharge ports.
